(19) United States
(12) Patent Application Publication
(10) Pub. No.: US 2007/0147067 A1
(43) Pub. Date: Jun. 28, 2007

(54) Flexible backlight module and system for manufacturing the same

(75) Inventors: Chia-Cheng Chuang, Tainan City (TW); Chung-Hsin Hsiao, Budai Town (TW)

Correspondence Address: BRUCE H. TROXELL, SUITE 1404, 5205 LEESBURG PIKE, FALLS CHURCH, VA, 22041, US

(73) Assignee: Industrial Technology Research Institute

(21) Appl. No.: 11/477,369

(22) Filed: Jun. 30, 2006

(30) Foreign Application Priority Data
Dec. 27, 2005 (TW) 094146654

(51) Int. Cl. F21V 7/04

(52) U.S. Cl. 362/600

(57) ABSTRACT

A flexible backlight module and a system for manufacturing the same. The flexible backlight module comprises: a bottom flexible panel, having a plurality of troughs arranged thereon; at least a light guide device, each being disposed in one of the troughs corresponding thereto, capable of guiding light to be discharged from the opening of the corresponding trough; and a top flexible panel, laid over the bottom flexible panel to receive the light discharged from each trough while emitting the received light therefrom. The system for manufacturing the flexible backlight module is capable of mass-producing the aforesaid flexible backlight module in an automatic fashion. The flexible backlight module of the invention can not only overcome the problems of high power consumption and heat dissipating in conventional backlight modules, but also be used as the light source of high brightness liquid crystal displays.

### BACKGROUND OF THE INVENTION

1. Field of the Invention:

The present invention generally relates to a flexible backlight module and a system for manufacturing the same and, more particularly, to a flexible backlight module combining a flexible panel and a light guiding device so as to emit light and a system capable of mass-producing the flexible backlight module in an automatic fashion.

2. Description of the Prior Art:

A liquid crystal display (LCD) generally comprises a backlight module and a liquid crystal module. Since the liquid crystal module does not emit light itself, it requires a backlight module to provide the LCD with enough luminescence so as to display images. In order to comply with consumers' requests, the backlight module is directed to reducing the weight and being less power-consuming. Especially for a backlight module using cold cathode fluorescent lamps (CCFLs), the number of CCFLs increases with the size of the LCD panel to bring forth problems such as high power-consumption, high operational temperature and high manufacturing cost.

Therefore, in order to overcome the afore-mentioned problems, U.S. Pat. No. 4,885,663 discloses a light emitting panel including an emitter surface in which optical fibers are woven into a sheet or a mat and coated with a material having a refractive index that will cause a change in the attenuation of the optical fibers in the emitter surface to increase the optical efficiency of the panel. Even though U.S. Pat. No. 4,885,663 overcomes the problems of the CCFL, it has shortcomings such as: (1) damage in the fibers caused when the fibers are woven into a sheet or a mat by mechanism; (2) low uniformity and poor utility efficiency of light due to uncontrollable light orientation; and (3) inability to upsize to meet the requirement of large-area displays.

Moreover, U.S. Pat. No. 5,432,876 discloses optical fibers provided with a series of optical elements of controlled morphology, pattern and spacing that find particular utility as a means of illumination. However, this disclosure is also problematic due to uncontrollable light orientation and small light-emitting angle.

Also, U.S. Pat. No. 6,247,826 discloses a thin sheet-form illumination device for illuminating objects using a flexible light guide plate with a light source on one side so as to emit light through bumps arranged on the surface of the light guide plate. However, this disclosure is also problematic in: (1) poor utility efficiency of light; (2) low illumination uniformity; (3) distortion of light path when the light guide plate is bended; and (4) lowered illumination intensity at a distance from the light source.

Therefore, there exists a need in providing a flexible backlight module and a system for manufacturing the same so as to overcome the problems of the aforementioned prior art references.

### SUMMARY OF THE INVENTION

It is a primary object of the present invention to provide a flexible backlight module combining a flexible panel and a light guiding device for guiding light so as to increase the efficiency of light and reduce power consumption.

It is a secondary object of the present invention to provide a flexible backlight module combining a flexible panel and a light guiding device for guiding light so as to achieve illumination uniformity and increase illumination intensity.

It is another object of the present invention to provide a flexible backlight module combining a flexible panel and a light guiding device for guiding light so as to reduce the volume and weight of the flexible backlight module for various illumination purposes anywhere.

It is still another object of the present invention to provide a system for manufacturing a flexible backlight module, capable of mass-producing the flexible backlight module in an automatic fashion so as to reduce the manufacturing cost.

In order to achieve the foregoing object, the present invention provides a flexible backlight module, comprising: a bottom flexible panel, having a plurality of troughs arranged thereon; at least a light guide device, each being disposed in one of the troughs corresponding thereto, capable of guiding light to be discharged from the opening of the corresponding trough; and a top flexible panel, laid over the bottom flexible panel to receive the light discharged from each trough while emitting the received light therefrom.

Preferably, the surface of each of the troughs is a reflecting surface.

Preferably, the reflecting surface is a spherical mirror with a focal point the light guide device is disposed at.

Preferably, the surface of each of the troughs has a metal film deposited thereon.

Preferably, a filler selected from a group including a liquid, at least a gas and combination thereof is provided between the troughs and the top flexible panel.

Preferably, the light guide device is coupled to a light source and a plurality of notches are arranged on a jacket layer of the light guide device so as to emit light.

Preferably, the light guide device is selected from a group including an optical fiber and a light guide beam.

Preferably, the flexible backlight module further comprises a plurality of micro lenses arranged on a light-emitting surface of the top flexible panel so as to focus the emitted light from the top flexible panel.

Preferably, the plurality of micro lenses are arranged to form a shape selected from a group including an arc shape, a polygon shape and combination thereof.

Preferably, the flexible backlight module further comprises a support member disposed between each of the light guide devices and each of the plurality of troughs.

The present invention further provides a system for manufacturing a flexible backlight module, the system comprising: a first transport device, carrying a bottom flexible panel to move corresponding to the first transport device; a first shaping device, disposed on the first transport device and having a plurality of bumps so as to form a plurality of troughs by exerting pressure on the plurality of bumps towards the bottom flexible panel; a deployment device, providing at least a light guide device on the each of the troughs; a second transport device, carrying a top flexible panel to move corresponding to the second transport device; and a combining device, receiving and exerting pressure on the bottom flexible panel transported on the first transport device and the top flexible panel transported on the second transport device so as to combine the bottom flexible panel and the top flexible panel.

Preferably, the first shaping device is one selected from a group including a roller and a punch.

Preferably, the system further comprises a second shaping device, disposed on the second transport device and having a plurality of pits so as to form a plurality of protrusions by exerting pressure on the plurality of pits towards the bottom flexible panel.

Preferably, the second shaping device is selected from a group including a roller and a punch.

Preferably, the system further comprises a coating device disposed between the first shaping device and the deployment device so as to form a thin film on the troughs.

Preferably, the system further comprises a filling device disposed between the deployment device and the combining device so as to fill the troughs with a filler selected from a group including a liquid, at least a gas and combination thereof.

Preferably, the combining device exerting pressure on the bottom flexible panel and the top flexible panel using a process selected from a group including agglutination, hot embossing and combination thereof.

The present invention further provides a flexible backlight module, comprising: a bottom flexible panel, having a plurality of troughs arranged thereon, the surface of each of the troughs being a reflecting surface; at least a light guide device, each being disposed in one of the troughs corresponding thereto, capable of guiding light to be discharged from the opening of the corresponding trough; and a top flexible panel comprising a plurality of micro lenses, laid over the bottom flexible panel to receive the light discharged from each trough while emitting the received light therefrom.

### BRIEF DESCRIPTION OF THE DRAWINGS

The objects, spirits and advantages of the preferred embodiments of the present invention will be readily understood by the accompanying drawings and detailed descriptions, wherein:

FIG. 1 is a schematic diagram of a flexible backlight module according to a first embodiment of the present invention;

FIG. 2A and FIG. 2B are schematic diagrams of a light guide device according to the first embodiment of the present invention;

FIG. 3A is a schematic diagram of a flexible backlight module according to a second embodiment of the present invention;

FIG. 3B is a cross-sectional view of a flexible backlight module according to a second embodiment of the present invention;

FIG. 3C is a schematic diagram of a flexible backlight module according to a third embodiment of the present invention;

FIG. 4A and FIG. 4B are cross-sectional views of a flexible backlight module according to a fourth embodiment of the present invention;

FIG. 5A and FIG. 5B are cross-sectional views of a flexible backlight module according to a fifth embodiment of the present invention;

FIG. 6 is a schematic diagram of a liquid crystal display using a flexible backlight module of the present invention; and

FIG. 7 is a system for manufacturing a flexible backlight module of the present invention.

### DETAILED DESCRIPTION OF THE PREFERRED EMBODIMENT

The present invention providing a flexible backlight module and a system for manufacturing the same can be exemplified by the preferred embodiments as described hereinafter.

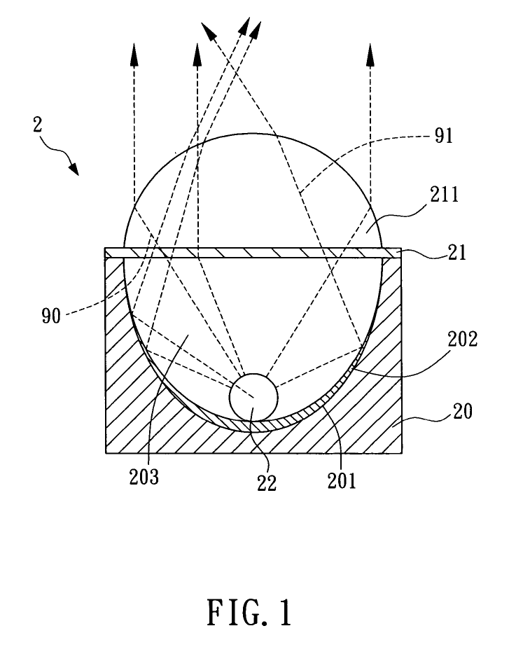

Please refer to FIG. 1, which is a schematic diagram of a flexible backlight module according to a first embodiment of the present invention. In FIG. 1, the flexible backlight module 2 comprises a bottom flexible panel 20 and a top flexible panel 21 laid over the bottom flexible panel 20. The top flexible panel 21 comprises a plurality of micro lenses 211 arranged on a light-emitting surface. The bottom flexible panel 20 comprises a plurality of troughs 201 arranged thereon. Each of the troughs 201 is a reflecting surface. In the present embodiment, the reflecting surface is a spherical mirror. In order to enhance reflection, the surface of each of the troughs 201 has a metal film 202 deposited thereon. Moreover, the flexible backlight module 2 further comprise at least a light guide device 22, each being disposed in one of the troughs 201 corresponding thereto, capable of guiding light from a light source. Preferably, the light guide device 22 is selected from a group including an optical fiber and a light guide beam. Moreover, a filler selected from a group including a liquid, at least a gas and combination thereof is provided in a space 203 between the troughs 201 and the top flexible panel 21 so as to adjust the focal distance of the corresponding micro lens 211.

According to the Lens Maker's Formula as described in Equ. (1), where O indicates the object, I indicates the image distance, f indicates the focal distance, n indicates the medium-to-lens refractive index, r′ indicates the radius of curvature of the first curved surface of the micro lens 211 and r″ indicates the radius of curvature of the second curved surface of the micro lens 211, the focal distance f of the micro lens 211 can be determined.

$$\frac{1}{o} + \frac{1}{i} = \frac{1}{f} = ( n - 1 ) ( \frac{1}{{r}^{′}} - \frac{1}{{r}^{′′}} ) \qquad ( 1 )$$

The light guide device 22 is disposed at the focal point of the micro lens 211. Therefore, the light from the focal point passes through the micro lens 211 and is refracted to generate parallel rays of light. For example, the light emitted from the light guide device 22 is diverged by the trough 201 into a light path 90 and a light path 91. The light path 90 enters the micro lens 211 and thus is refracted by the top flexible panel 211 as parallel rays of light because the light guide device 22 is disposed at the focal point of the micro lens 211. On the other hand, the light path 91 is reflected by the reflecting surface of the trough 201 and then enters the micro lens 211 so as to be converged by the micro lens 211 and then emitted from the top flexible panel 21.

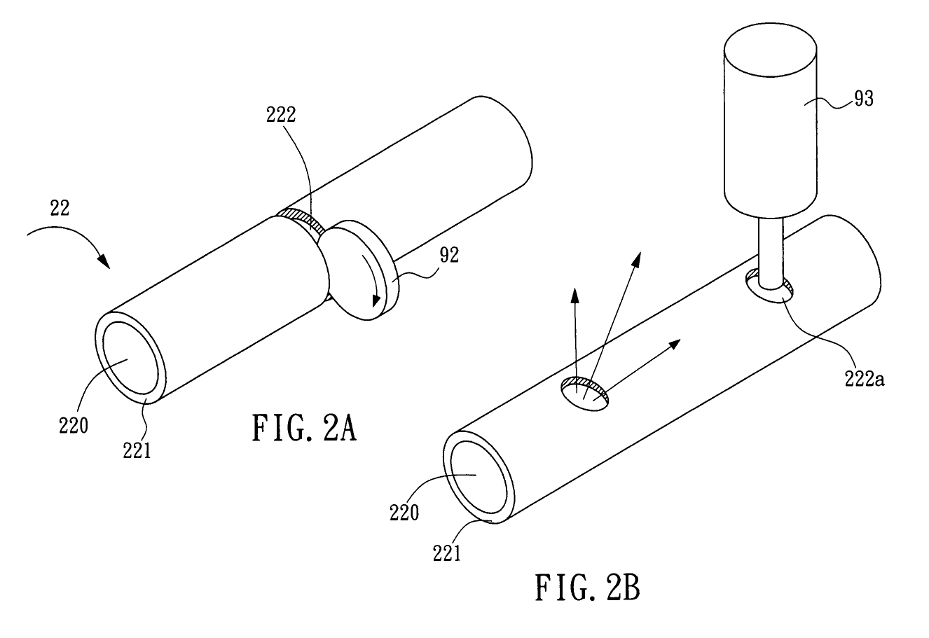

Please further refer to FIG. 2A and FIG. 2B, which are schematic diagrams of a light guide device according to the first embodiment of the present invention. In the present embodiment, the light guide device 22 is implemented using an optical fiber. The optical fiber 22 comprises a core 220 and a jacket layer 221. The light travels in the core 220 due to total reflection. When the light is to be discharged from a certain region on the optical fiber 22, the jacket layer 221 at a corresponding region 222 of the optical fiber 22 is removed so as to emit light from the corresponding region 222. As shown in FIG. 2A, the jacket layer 221 at the corresponding region 222 is removed using mechanism such as a cutting tool 92. Alternatively, as shown in FIG. 2B, the jacket layer 221 at the corresponding light-emitting region 222a can also be removed using laser 93. Alternatively, the jacket layer 221 at the corresponding light-emitting region 222a can also be removed using wet etching.

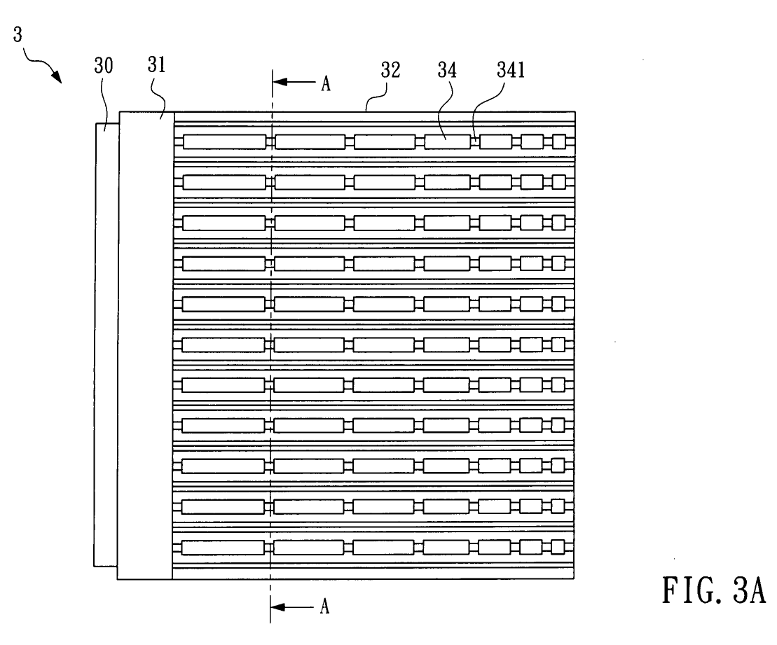

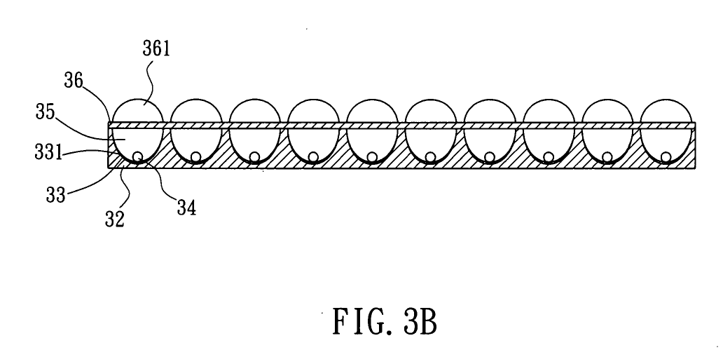

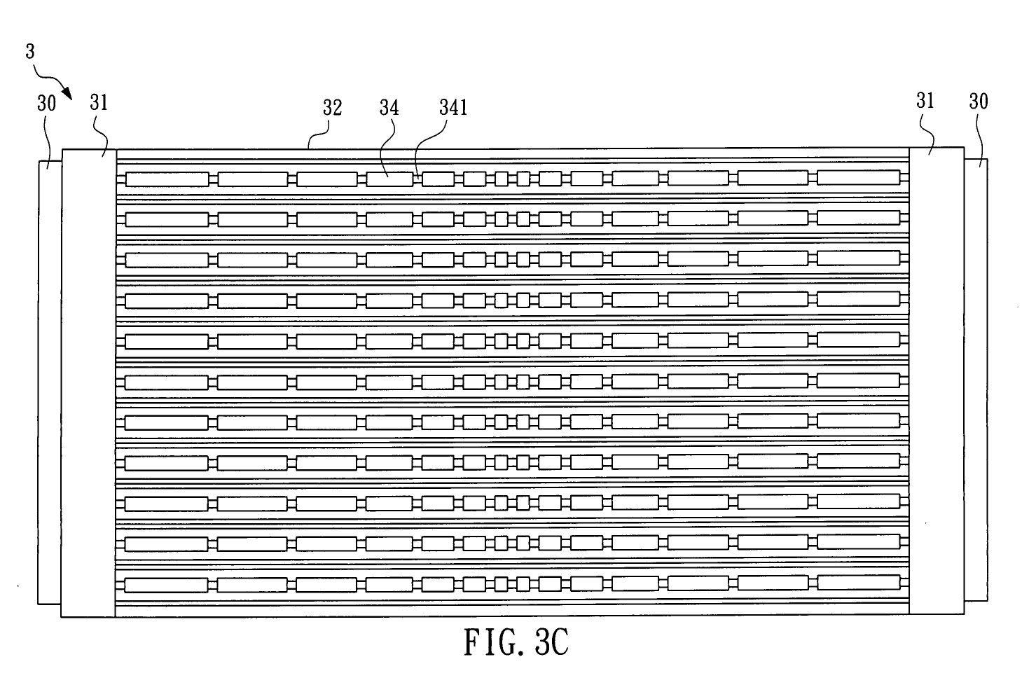

Please refer to FIG. 3A, which is a schematic diagram of a flexible backlight module according to a second embodiment of the present invention. In FIG. 3A, the flexible backlight module 3 comprises a light source 30 disposed on one side of a plurality of light guide devices 34. The light guide devices 34 are integrated by an integrating device 31 to align the light guide devices 34 and the light source 30 so that the light emitted from the light source 30 entirely enters the light guide devices 34. The light guide devices 34 comprise a plurality of light-emitting regions 341 for light emitting. The position of each light-emitting region 341 is arranged according to practical uses. In the present embodiment, the spacing between two adjacent light-emitting regions 341 is smaller when they are farther from the light source 30; on the contrary, the spacing between two adjacent light-emitting regions 341 is larger when they are closer to the light source 30. However, this embodiment is only exemplary but not to limit the present invention. Moreover, The light source 30 is implemented using a CCFL, an LED or any other light bulb with high-brightness visible light, VU light or infrared rays.

Referring to FIG. 3B, which is a cross-sectional view of a flexible backlight module according to a second embodiment of the present invention, the top flexible panel 36 is laid over the bottom flexible panel 32. A plurality of micro lenses 361 formed of a transparent material are arranged on a light-emitting surface of the top flexible panel 36. The transparent material can be plastic, polymer or resin but is not limited thereto. The bottom flexible panel 32 can be transparent or opaque such as plastic, polymer or resin but is not limited thereto. The bottom flexible panel 32 comprises a plurality of troughs 33 arranged thereon. Each of the troughs 33 is a reflecting surface. In the present embodiment, the reflecting surface is a spherical mirror. In order to enhance reflection, the surface of each of the troughs 33 has a metal film 331 deposited thereon. Moreover, the flexible backlight module further comprise at least a light guide device 34, each being disposed in one of the troughs 33 corresponding thereto, capable of guiding light from a light source. Preferably, the light guide device 34 is selected from a group including an optical fiber and a light guide beam. Moreover, a filler selected from a group including a liquid, at least a gas and combination thereof is provided in a space 35 between the troughs 33 and the top flexible panel 36 so as to adjust the focal distance of the corresponding micro lens 361.

FIG. 3C is a schematic diagram of a flexible backlight module according to a third embodiment of the present invention. In FIG. 3C, when the employed light source does not have insufficient power, two light sources 30 can be installed on both sides of the light guide devices 34. These two light sources 30 can be identical or different. For example, two light sources 30 with different colors can be installed on both sides of the light guide devices 34 so as to mix the two colors in the light guide devices 34. In addition, the light source is easily removed or replaced when damaged. Therefore, the flexible backlight module of the present invention exhibits a longer lifetime.

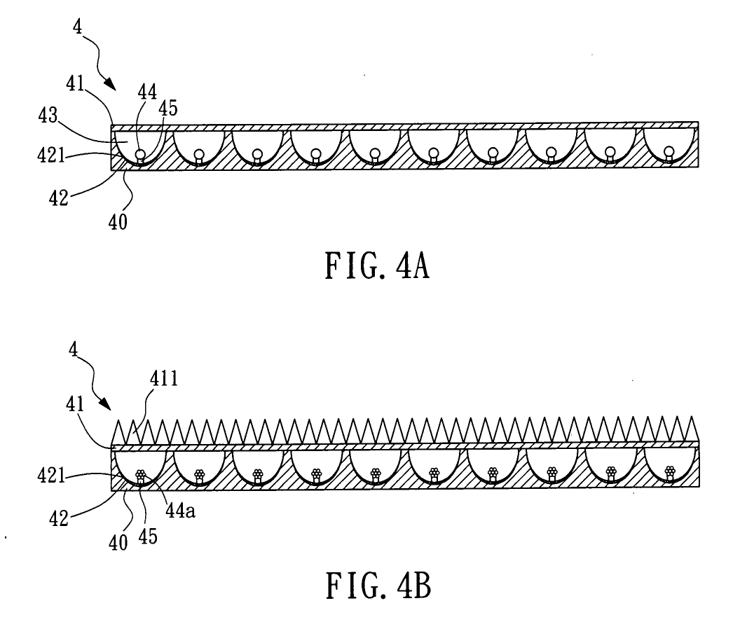

Please refer to FIG. 4A and FIG. 4B, which are cross-sectional views of a flexible backlight module according to a fourth embodiment of the present invention. In FIG. 4A, the flexible backlight module 4 comprises a bottom flexible panel 40 and a top flexible panel 41 laid over the bottom flexible panel 40. The top flexible panel 41 is a transparent flat panel and the bottom flexible panel 40 is a transparent or opaque flexible panel. The employed materials are as aforementioned. The bottom flexible panel 40 comprises a plurality of troughs 42 arranged thereon. Each of the troughs 42 is a reflecting surface. In the present embodiment, the reflecting surface is a spherical mirror. In order to enhance reflection, the surface of each of the troughs 42 has a metal film 421 deposited thereon. Moreover, the flexible backlight module 4 further comprises a support member 45 disposed between each of the light guide devices 44 and each of the plurality of troughs 42 so as to support the light guide devices 44. In the present embodiment, each of the plurality of troughs 42 is installed on the top of the support member 45 so that the light guide device 44 is positioned at the focal point of the trough 42. Theoretically, the light from the focal point is reflected by the spherical mirror to become parallel rays of light. Therefore, the light from the light guide device 44 passes the top flexible panel 41 as parallel rays of light. Moreover, a filler selected from a group including a liquid, at least a gas and combination thereof is provided in a space 43 between the troughs 42 and the top flexible panel 41.

In FIG. 4B, the light guide device 44a supported by the support member 45 in the present embodiment can be an optical fiber beam formed of a plurality of optical fibers bundled together. The emitted light is reflected by the spherical mirror of the troughs 42 as parallel rays of light. Therefore, a plurality of triangular micro lenses 411 are further provided on the top flexible panel 41 so as to converge the non-parallel rays of light for higher light source efficiency. However, the micro lenses 411 can also be arc shaped, polygon shaped and combination thereof.

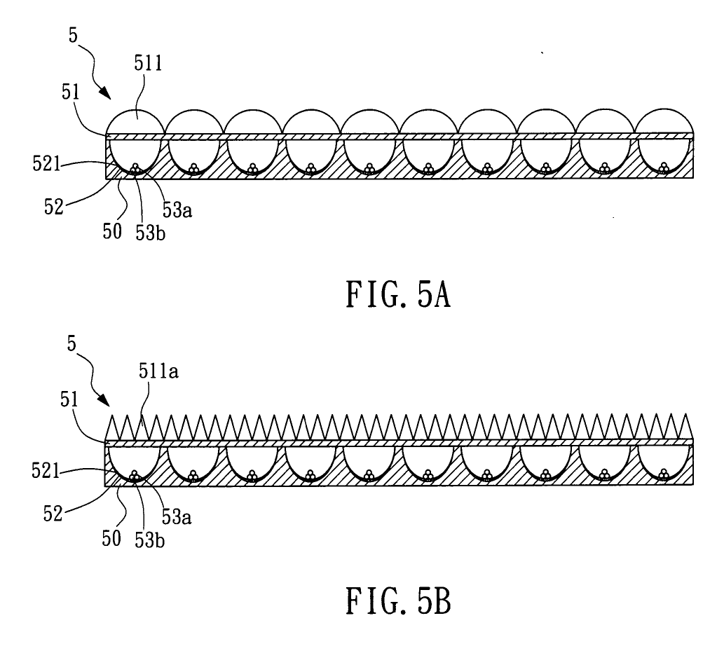

Please refer to FIG. 5A and FIG. 5B, which are cross-sectional views of a flexible backlight module according to a fifth embodiment of the present invention. In FIG. 5A, the flexible backlight module 5 comprises a bottom flexible panel 50 and a top flexible panel 51 laid over the bottom flexible panel 50. The bottom flexible panel 50 comprises a plurality of troughs 52 arranged thereon. Each of the troughs 52 is a reflecting surface. In the present embodiment, the reflecting surface is a spherical mirror. In order to enhance reflection, the surface of each of the troughs 52 has a metal film 521 deposited thereon. The flexible backlight module 5 comprises a plurality of stacked light guide devices 53a and 53b in the troughs 52. In the present embodiment, the upper light guide device 53a is disposed at the focal point of the trough 52 so that the light emitted from the light guide device 53a is reflected by the spherical mirror of the trough 52 as parallel rays of light from the top flexible panel 51. In order to converge the non-parallel rays of light from the other light guide devices 53b that are not disposed at the focal point, a plurality of micro lenses 511 are further provided on the top flexible panel 51 for higher light source efficiency. In the present embodiment, the micro lenses 511 are arc shaped. On the other hand, as shown In FIG. 5B, the micro lenses 511a can have a polygon shape such as a triangle.

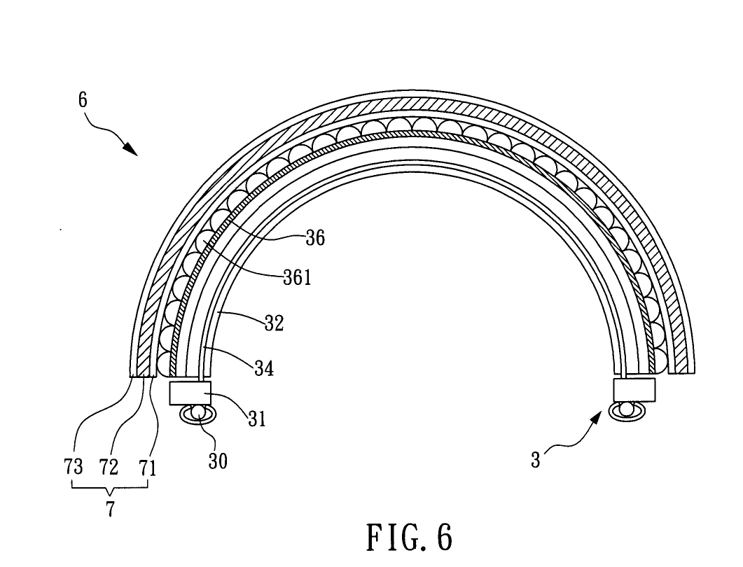

Please refer to FIG. 6, which is a schematic diagram of a liquid crystal display using a flexible backlight module of the present invention. The present embodiment is exemplified using the second embodiment and a liquid crystal module. The liquid crystal display 6 comprises a liquid crystal module 7 and a flexible backlight module 3. The liquid crystal module 7 comprises a top panel 73, a bottom panel 71 and liquid crystals 72 between the top panel 73 and the bottom panel 71. The flexible backlight module 3 is disposed under the liquid crystal module 7. The flexible backlight module 3 has high flexibility and thus can be shaped according to the object to be illuminated. In the present embodiment as shown in FIG. 6, the liquid crystal module 7 has a radius of curvature. Conventional non-flexible backlight modules have no flexibility and thus cannot be integrated with the liquid crystal module 7 in FIG. 6 to provide high-uniformity illumination. Therefore, the flexible backlight module 3 of the present invention can match up the curvature of the liquid crystal module 7 so as to provide uniform illumination.

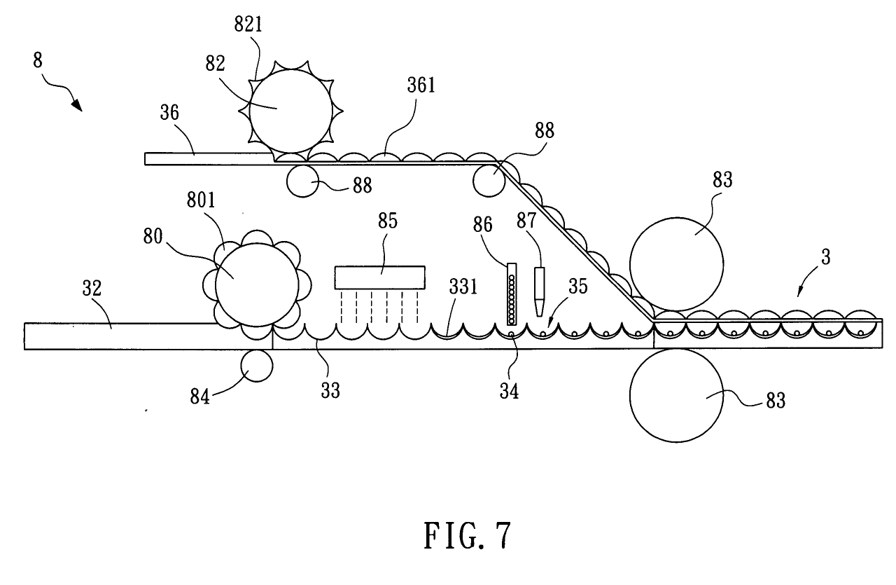

FIG. 7 is a system for manufacturing a flexible backlight module of the present invention. The system of the present invention is exemplified using the second embodiment. The system 8 comprises a first transport device 84, a first shaping device 80, a deployment device 86, a second transport device 88 and a combining device 83. The first transport device 84 carries a bottom flexible panel 32 to move corresponding to the first transport device 84. The first transport device 84 comprises a plurality of steering-wheels for transportation. Alternatively, the first transport device 84 can be a transportation belt. During transportation, the first shaping device 80 performs micro-pressing so as to form a plurality of troughs 33 on the bottom flexible panel 32. The first shaping device 80 is disposed on the first transport device 84 and has a plurality of bumps 801 so as to form a plurality of troughs 33 by exerting pressure on the plurality of bumps 801 towards the bottom flexible panel 32. In the present embodiment, each of the troughs 33 is a spherical mirror. The first shaping device 80 is a roller for rolling over the bottom flexible panel 32 to form the troughs. Alternatively, the first shaping device 80 is a punch for punching the bottom flexible panel 32 to form the troughs. During micro-pressing, a heating device (not shown) can be provided to heat up the bottom flexible panel 32 and the first shaping device 80 so as to facilitate to form the troughs 33.

In order to enhance the reflection efficiency of the troughs 33, a coating device 85 is provided between the first-shaping device 80 and the deployment device 86 so as to form a thin film 331 on the troughs 33. The thin film 331 is then baked or cooled down. The bottom flexible panel 32 passes through the deployment device 86. The deployment device 86 provides at least a light guide device 34 on the each of the troughs 33. The jacket layer at the light-emitting regions of light guide device 34 is removed beforehand and therefore, the light guide device 34 provided by the deployment device 86 is directly mounted on one of the troughs 33. The system 8 further comprises a filling device 87 to fill the troughs 33 with a filler selected from a group including a liquid, at least a gas and combination thereof.

The second transport device 88 carries a top flexible panel 36 to move corresponding to the second transport device 88. The second transport device 88 comprises a plurality of steering-wheels for transportation. The top flexible panel 36 passes through a second shaping device 82 to perform micro-pressing so as to form a plurality of micro lenses 361 on the top flexible panel 36. The second shaping device 82 is disposed on the second transport device 88 and has a plurality of pits 821 so as to form the micro lenses 361 by exerting pressure on the plurality of pits 821 towards the top flexible panel 36. In the present embodiment, during micro-pressing, a heating device (not shown) can be provided to heat up the top flexible panel 36 and the second shaping device 82 so as to facilitate to form the micro lenses 361. The second shaping device 82 is a roller for rolling over the top flexible panel 36 to form the micro lenses 361. Alternatively, the second shaping device 82 is a punch for punching the top flexible panel 36 to form the micro lenses 361.

Furthermore, the combining device 83 receives and exerts pressure on the bottom flexible panel 32 transported on the first transport device 84 and the top flexible panel 36 transported on the second transport device 88 so as to combine the bottom flexible panel 32 and the top flexible panel 36. In the present embodiment, the combining device 83 comprises a top steering-wheel and a bottom steering-wheel but is not limited thereto so as to exert enough pressure for combining the bottom flexible panel 32 and the top flexible panel 36. The bottom flexible panel 32 and the top flexible panel 36 are combined using glue coating on the interface of the bottom flexible panel 32 and the top flexible panel 36. Alternatively, the filling device 87 is used to fill with a viscous liquid. Alternatively, the bottom flexible panel 32 and the top flexible panel 36 are combined using a process selected from a group including agglutination, hot embossing and combination thereof.

According to the above discussion, it is apparent that the present invention discloses a flexible backlight module combining a flexible panel and a light guiding device so as to emit light and a system capable of mass-producing the flexible backlight module in an automatic fashion. The disclosed flexible backlight module has advantages such as:

(1) capability in serving a backlight module of a liquid crystal display to overcome the problems of conventional backlight module;

(2) higher power efficiency, lower power consumption and compactness in size;

(3) high uniformity in illumination due to high orientation flexibility;

(4) low operational temperature due to the use of the optical fiber for guiding light;

(5) controllable light-emitting regions for uniform illumination;

(6) simple configuration with light weight by mass-producing in an automatic fashion to reduce the manufacturing cost;

(7) brightness enhancement by using micro lenses to converge the light;

(8) various illumination purposes such as displays, advertisements, traffic signs, etc.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A flexible backlight module, comprising:
a bottom flexible panel, having a plurality of troughs arranged thereon;
at least a light guide device, each being disposed in one of the troughs corresponding thereto, capable of guiding light to be discharged from the opening of the corresponding trough; and
a top flexible panel, laid over the bottom flexible panel to receive the light discharged from each trough while emitting the received light therefrom.

2. The flexible backlight module as recited in claim 1, wherein the surface of each of the troughs is a reflecting surface.

3. The flexible backlight module as recited in claim 2, wherein the reflecting surface is a spherical mirror with a focal point the light guide device is disposed at.

4. The flexible backlight module as recited in claim 1, wherein the surface of each of the troughs has a metal film deposited thereon.

5. The flexible backlight module as recited in claim 1, wherein a filler selected from a group including a liquid, at least a gas and combination thereof is provided between the troughs and the top flexible panel.

6. The flexible backlight module as recited in claim 1, wherein the light guide device is coupled to a light source and a plurality of notches are arranged on a jacket layer of the light guide device so as to emit light.

7. The flexible backlight module as recited in claim 6, wherein the light guide device is selected from a group including an optical fiber and a light guide beam.

8. The flexible backlight module as recited in claim 1, further comprising a plurality of micro lenses arranged on a light-emitting surface of the top flexible panel so as to focus the emitted light from the top flexible panel.

9. The flexible backlight module as recited in claim 8, wherein the plurality of micro lenses are arranged to form a shape selected from a group including an arc shape, a polygon shape and combination thereof.

10. The flexible backlight module as recited in claim 1, further comprising a support member disposed between each of the light guide devices and each of the plurality of troughs.

11. A system for manufacturing a flexible backlight module, comprising:
a first transport device, carrying a bottom flexible panel to move corresponding to the first transport device;
a first shaping device, disposed on the first transport device and having a plurality of bumps so as to form a plurality of troughs by exerting pressure on the plurality of bumps towards the bottom flexible panel;
a deployment device, providing at least a light guide device on the each of the troughs;
a second transport device, carrying a top flexible panel to move corresponding to the second transport device; and
a combining device, receiving and exerting pressure on the bottom flexible panel transported on the first transport device and the top flexible panel transported on the second transport device so as to combine the bottom flexible panel and the top flexible panel.

12. The system as recited in claim 11, wherein the first shaping device is one selected from a group including a roller and a punch.

13. The system as recited in claim 11, further comprising a second shaping device, disposed on the second transport device and having a plurality of pits so as to form a plurality of protrusions by exerting pressure on the plurality of pits towards the bottom flexible panel.

14. The system as recited in claim 13, wherein the second shaping device is selected from a group including a roller and a punch.

15. The system as recited in claim 11, further comprising a coating device disposed between the first shaping device and the deployment device so as to form a thin film on the troughs.

16. The system as recited in claim 11, further comprising a filling device disposed between the deployment device and the combining device so as to fill the troughs with a filler selected from a group including a liquid, at least a gas and combination thereof.

17. The system as recited in claim 11, wherein the combining device exerting pressure on the bottom flexible panel and the top flexible panel using a process selected from a group including agglutination, hot embossing and combination thereof.

18. A flexible backlight module, comprising:
a bottom flexible panel, having a plurality of troughs arranged thereon, the surface of each of the troughs being a reflecting surface;
at least a light guide device, each being disposed in one of the troughs corresponding thereto, capable of guiding light to be discharged from the opening of the corresponding trough; and
a top flexible panel comprising a plurality of micro lenses, laid over the bottom flexible panel to receive the light discharged from each trough while emitting the received light therefrom.

19. The flexible backlight module as recited in claim 18, wherein the reflecting surface is a spherical mirror with a focal point the light guide device is disposed at.

20. The flexible backlight module as recited in claim 18, wherein the surface of each of the troughs has a metal film deposited thereon.

21. The flexible backlight module as recited in claim 18, wherein a filler selected from a group including a liquid, at least a gas and combination thereof is provided between the troughs and the top flexible panel.

22. The flexible backlight module as recited in claim 18, wherein the light guide device is coupled to a light source and a plurality of notches are arranged on a jacket layer of the light guide device so as to emit light.

23. The flexible backlight module as recited in claim 22, wherein the light guide device is selected from a group including an optical fiber and a light guide beam.

24. The flexible backlight module as recited in claim 18, wherein the plurality of micro lenses are arranged to form a shape selected from a group including an arc shape, a polygon shape and combination thereof.

25. The flexible backlight module as recited in claim 18, further comprising a support member disposed between each of the light guide devices and each of the plurality of troughs.
